(19) United States
(12) Patent Application Publication
(10) Pub. No.: US 2006/0114267 A1
(43) Pub. Date: Jun. 1, 2006

(54) Apparatus and method for displaying power-saving level

(75) Inventor: Hee-jun Park, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/267,218

(22) Filed: Nov. 7, 2005

(30) Foreign Application Priority Data
Nov. 13, 2004 (KR) 10-2004-0092820

(51) Int. Cl. G09G 5/00

(52) U.S. Cl. 345/619

(57) ABSTRACT

An apparatus and a method for displaying a power-saving level. The apparatus includes a peripheral unit including a plurality of modules that operates by power supplied by a power unit, a user input unit to which a predetermined power-saving mode and power-saving state values for modules corresponding to the power-saving mode are input, a controller calculating power-saving level values using the input power-saving state values and providing information about the calculated power-saving level values, and a display unit providing the information to a user.

### CROSS-REFERENCE TO RELATED APPLICATION

This application claims priority from Korean Patent Application No. 10-2004-0092820 filed on Nov. 13, 2004 in the Korean Intellectual Property Office, the disclosure of which is incorporated herein by reference.

### BACKGROUND OF THE INVENTION

1. Field of the Invention

The present invention relates to power-saving level display, and more particularly, to an apparatus and a method for providing an interface in which the power-saving level of a portable electronic device that operates using a battery or rechargeable battery can be easily recognized by a user and a desired power-saving level can be adjusted by the user.

2. Description of Related Art

As portable electronic devices such as notebook computers, and the like, have been widely used along with the development of technology, power supply has become more and more important. That is, since power is supplied to portable electronic devices using batteries or rechargeable cells, a user doesn't want to waste excessive power and to keep an optimum power-saving state according to use. Thus, in the conventional art, an application program for power management is mounted on portable electronic devices so that the user can recognize a power management state, which is shown in FIGS. 1A through 1C.

In FIG. 2, a current expected time required for using a battery or rechargeable battery is visually displayed to the user so that a current power state can be recognized. In this case, in consideration of the load of a process and the remaining amount of a battery that operates in a current portable electronic device, the expected time required for using the battery is calculated and displayed.

However, in the above conventional method, when set values for a variety of modules that operate by power supplied in portable electronic devices such as a notebook computer, and the like are changed, an effect thereof cannot be provided to the user in real-time so that the user cannot recognize how a respective setting affects the power-saving state of the portable electronic device.

Accordingly, there exist a need for a method to easily recognize when set values for modules are changed or how a power-saving state is changed according to the performance modes of portable electronic devices, for example, whether power-saving will be centered or whether the performance of a system will be maximized.

### BRIEF SUMMARY

An aspect of the present invention provides an apparatus and a method for providing an interface in which the power-saving level of a portable electronic device that operates using a battery or rechargeable battery can be easily recognized by a user and a desired power-saving level can be adjusted by the user.

According to an aspect of the present invention, there is provided an apparatus for displaying a power-saving level. The apparatus includes a peripheral unit including a plurality of modules that operates by the supplied power supplied by a power unit; a user input unit to which a predetermined power-saving mode and power-saving state values for the modules corresponding to the power-saving mode are input; a controller calculating power-saving level values using the input power-saving state values and providing information about the calculated power-saving level values; and a display unit providing the information to a user.

According to another aspect of the present invention, there is provided a user interface for an apparatus for displaying a power-saving level. The user interface includes: a first region including an icon representing a plurality of power-saving modes, a second region providing a plurality of power-saving state values corresponding to the power-saving modes, a third region including an icon for a control input to perform an operation for calculating a power-saving level value using the power-saving state values set in the second region, and a fourth region providing information about the power-saving state value calculated by the control input.

According to still another aspect of the present invention, there is provided a method of displaying a power-saving level, the method including: receiving a predetermined power-saving mode and power-saving state values for modules corresponding to the power-saving mode, calculating power-saving level values using the input power-saving state values, and providing information about the calculated power-saving level values.

According to another aspect of the present invention, there is provided an apparatus for displaying a power-saving level, the apparatus including: peripheral means including a plurality of modules that operate by supplied power; user input means for receiving a predetermined power-saving mode input and power-saving state values for modules corresponding to the power-saving mode; and control means for calculating power-saving level values using the received power-saving state values and providing information about the calculated power-saving level values.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIGS. 1A through 1C are exemplary views of a conventional user interface for power management;

FIG. 2 is an exemplary view of a conventional user interface representing a power state;

FIG. 3 is an exemplary block diagram of an apparatus for displaying a power-saving level according to an embodiment of the present invention;

FIG. 4 is a flowchart illustrating a method of displaying a power-saving level according to an embodiment of the present invention;

FIG. 5 is an exemplary view of the initial screen of a user interface for displaying a power-saving level according to an embodiment of the present invention;

FIG. 6 is an exemplary view of a user interface in a maximum battery mode according to an embodiment of the present invention;

FIG. 7 is an exemplary view of a user interface in a normal mode according to an embodiment of the present invention;

FIG. 8 is an exemplary view of a user interface in a maximum performance mode according to an embodiment of the present invention;

FIG. 9 is an exemplary view of a user interface in a user setting mode according to an embodiment of the present invention; and

FIG. 10 is an exemplary view of a user interface in a user setting mode according to another embodiment of the present invention.

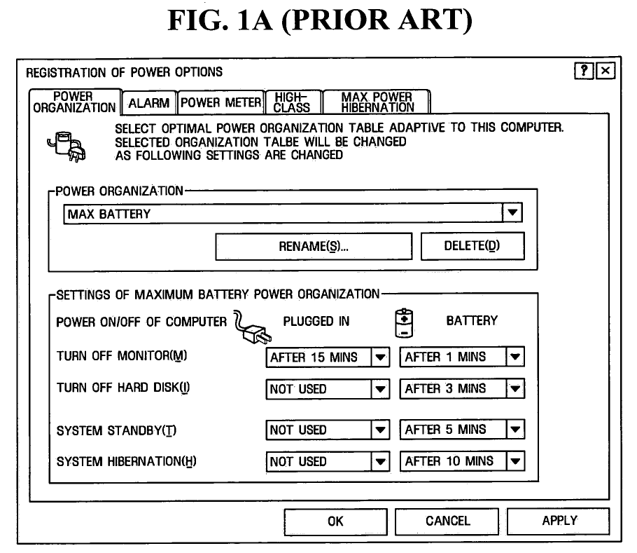

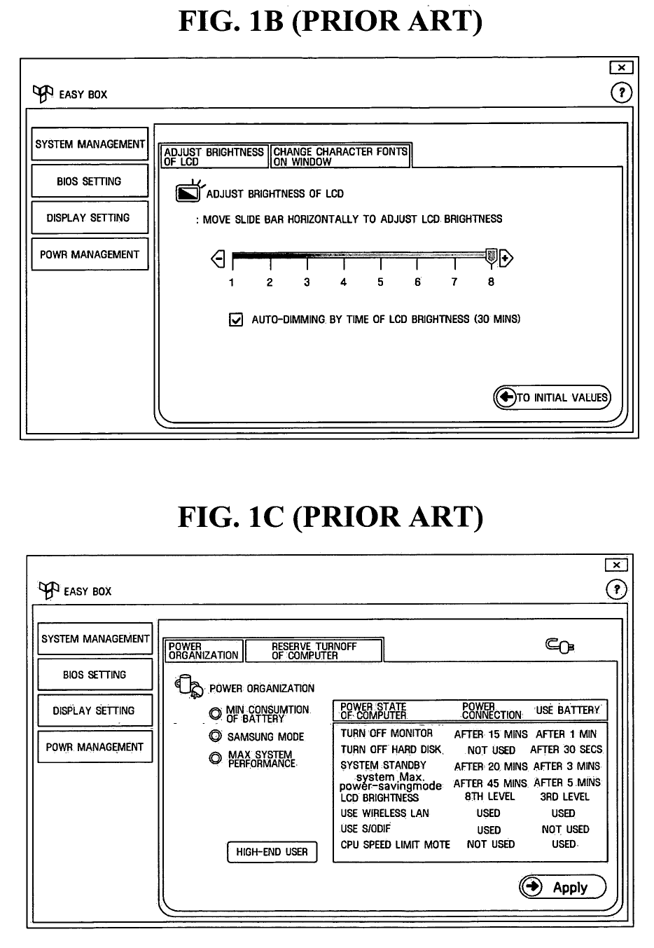

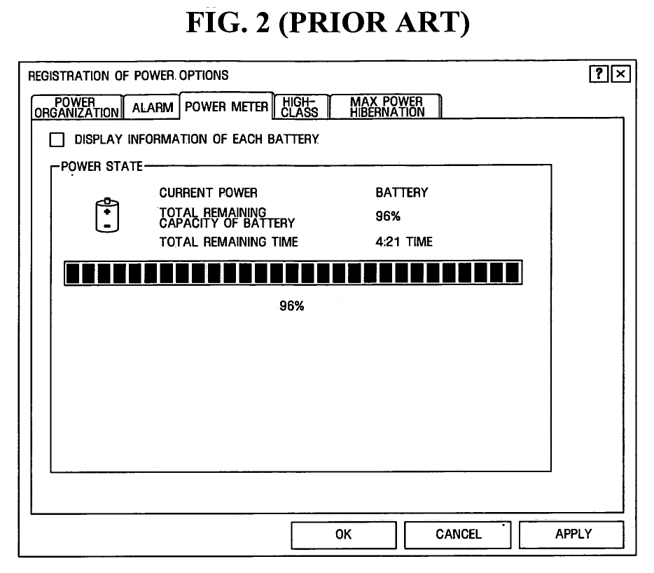

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Embodiments of the present invention are described hereinafter with reference to, among other illustrations, flowchart illustrations of a method. It will be understood that each block of the flowchart illustrations, and combinations of blocks in the flowchart illustrations, can be implemented by computer program instructions. These computer program instructions can be provided to the processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Hereinafter, an index representing a power-saving effect by adjusting power consumed in each of modules constituting a device that operates by power is referred to as a ‘power-saving level’, and a value set to adjust consumed power is referred to as a ‘power-saving state value’.

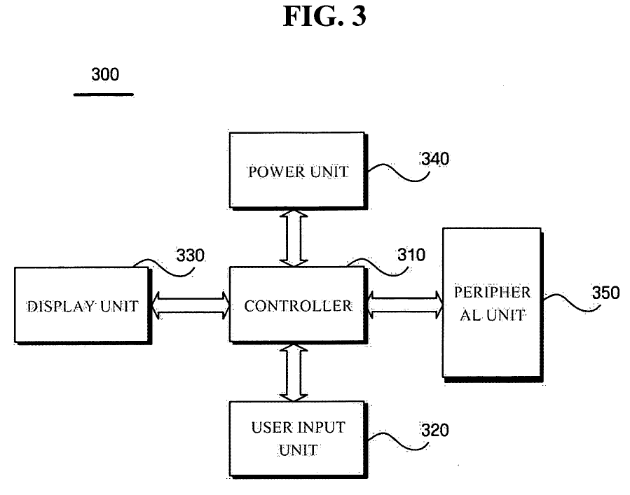

FIG. 3 is an exemplary block diagram of an apparatus for displaying a power-saving level according to an embodiment of the present invention. The apparatus 300 for displaying a power-saving level of FIG. 3 includes a power unit 340, a peripheral unit 350, a user input unit 320, a controller 310, and a display unit 330.

The term ‘unit’, as used herein, means, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

The power unit 340 supplies power to the apparatus 300 for displaying a power-saving level. In this case, a battery or rechargeable battery can be used.

The peripheral unit 350 includes a plurality of modules that operate by power supplied by the power unit 340. In this case, the modules may include a data storage medium such as a hard disc, a fan, a wireless LAN module, and the like.

A predetermined power-saving mode and a power-saving state value for the modules corresponding to the power-saving mode are input to the user input unit 320, and the controller 310 calculates the power-saving level value using the input power-saving state value. The display unit 330 displays information about the calculated power-saving level value to the user.

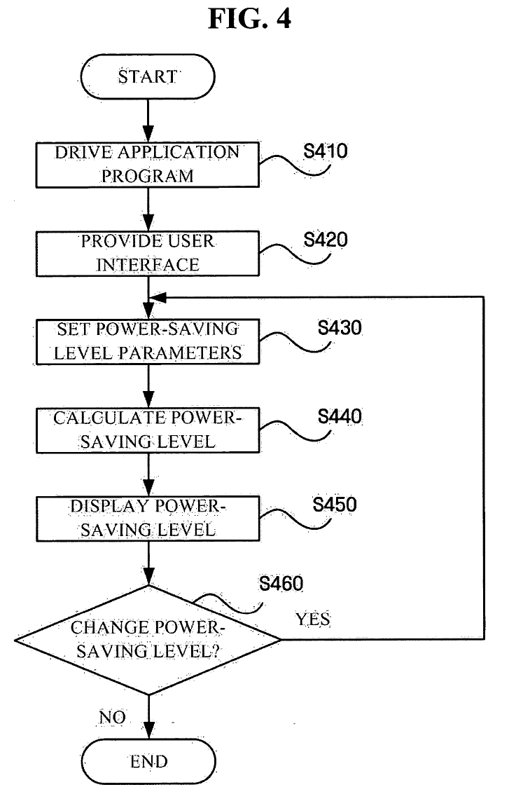

Operations of the power unit 340, the peripheral unit 350, the user input unit 320, the controller 310, and the display unit 330 will be described with reference to FIGS. 4-10.

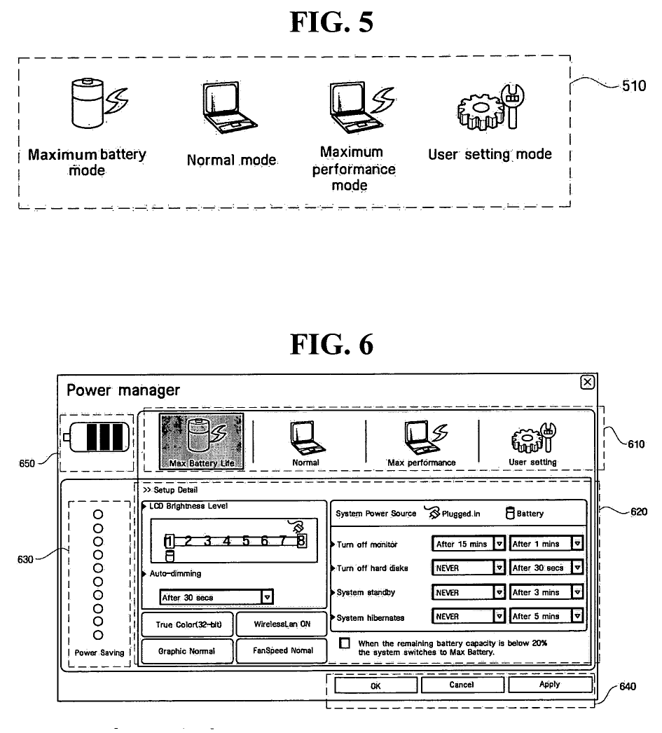

If the controller 310 drives an application program mounted in the apparatus 300 according to a user's request for setting a power-saving level in operation S410, a user interface is provided to the user via the display unit 330 in operation S420. In this case, an example of an initial screen of the user interface is shown in FIG. 5.

Then, the user sets parameters for obtaining the power-saving level in operation S430. The parameters include information about a power-saving mode and information about a power-saving state value. For example, the user can select a desired power-saving mode in a power-saving mode selection region 510 of the initial screen shown in FIG. 5. In FIG. 5, as an example of a power-saving mode, a maximum battery mode, a normal mode, a maximum performance mode, and a user setting mode are represented. The maximum battery mode is a mode in which the battery in the power unit 340 can be used for the longest possible time period. The maximum performance mode is a mode in which the performance of the apparatus 300 can be maximized, and the normal mode is a mode in which a power-saving is set to a mid level between the maximum battery mode and the maximum performance mode. In addition, the user setting mode is a mode in which the user sets a power-saving state value for the modules that operates on power to obtain a desired power-saving level.

For example, when the user selects the maximum battery mode, a user interface shown in FIG. 6 is provided. The user interface includes a first region 610 for selecting a power-saving mode, a second region 620 for providing a plurality of power-saving state values corresponding to the selected power-saving mode, a third region 640 including an icon for a control input to perform an operation for calculating the power-saving level value using the power-saving state values set in the second region 620 or an icon for cancelling a set power-saving state value, a fourth region 630 for providing information about the power-saving state value calculated by the control input, and a fifth region 650 for providing information about the state of a current battery. The information provided in the fifth region 650 is information in which the controller 310 directly checks the state of the power unit 340 to provide the state of the power unit 340 to the user via the display unit 330. Currently, in the first region 610, an icon representing the maximum battery mode is indicated by shadow and represents the state of the current power-saving mode is the maximum battery mode. In the second region 620, the power-saving state values are provided. Preferably, in the maximum battery mode, the power-saving state values are previously fixed so that the user cannot change them arbitrarily. In the fourth region 630, the power-saving level in the maximum battery mode is represented. The information about the power-saving level can be obtained by performing an operation for predetermined the power-saving state values by the controller 310 in operation S440. A method of calculating the power-saving state values will now be described.

For example, information about a power-saving level such as adjusting of brightness of an LCD, the time required for automatically reducing brightness of the LCD, whether the state of display is determined to be 16-bit high color or 32-bit true color, whether a wireless LAN module is turned on or off, whether the performance of graphics is in a normal mode or a power-saving mode, adjusting of speed of a fan, and a power state of a computer, for example, a time when a monitor is turned off, a time when a hard disc is turned off, a system standby mode time, and the like are provided in the second region 620. Variables for various kinds of information are set and values corresponding to the information provided in the second region 620 are stored in the corresponding variables. Then, functions are executed by using each variable as an input and the executed resultant values can be set to the power-saving level values. Preferably, the functions are to perform an addition operation on the respective variables altogether or an addition operation the respective variables with weights assigned thereto.

For example, a variable for representing brightness of an LCD can be set to Y1, a variable for representing a time required for automatically reducing brightness of the LCD can be set to Y2, a variable for representing high-performance graphics can be set to Y4, a variable for representing a wireless LAN can be set to Y5, a variable for representing turn-off of the monitor can be set to Y6, and a variable for representing turn-off of the hard disc can be set to Y7, and after each of the values for the variables is obtained, a power-saving level Y can be represented as shown in Equation 1.
Y=Y4+Y5+Y7+(Y1+Y2+Y6)/3 (1)

In this case, when Y1 (LCD brightness), Y2 (time required for reducing LCD brightness), and Y6 (turn-off of the monitor) are set altogether, values representing a power-level are multiplied by ⅓ so that the power-saving state in relation to a screen is repeatedly reflected in the value representing the power-level.

As another method of obtaining power-level values, weighed values are set to the respective variables according to the degree of the effect on power-saving and the values of each variable are added so that the power-saving level values can be obtained. For example, since Y1 (LCD brightness), Y2 (time required for reducing LCD brightness), and Y6 (turn-off of the monitor) greatly affect power-saving, high weighed values are given to Y1, Y2, and Y6, and since Y4 (high-performance graphics), Y5 (wireless LAN), and Y7 (turn-off of the hard disc) slightly affect power-saving, low weighed values are given to Y4, Y5, and Y7.

Power-saving levels can be calculated using the weighed values. However, as a more precise method, the effect of settings for each device on the time required for using a battery during the total performance time in the same environment when the time required for using a battery is tested can be calculated so that power-saving levels can be calculated. That is, power-saving levels can be calculated so that different function settings for the same device are not repeatedly reflected in the power-saving levels. For example, when Y1 (LCD brightness), Y2 (time required for reducing LCD brightness), and Y6 (turn-off of the monitor) are set altogether, only values corresponding to the effect in which LCD is turned off are reflected on the power-saving levels.

As shown in FIG. 6, to visually display a power-saving level to a user, all 10 circles in the fourth region 630 are displayed in a maximum power-saving state while all 10 circles disappear in a minimum power-saving state. That is, as the number of circles increases, a power-saving effect increases. A method of displaying a power-saving level is not necessarily limited to the above method, and any method of visually displaying the state of a power-saving level to the user can be performed. In FIG. 6, since a current power-saving mode is a maximum battery mode, the power-saving level in the fourth region 630 is displayed in a maximum state in operation S450.

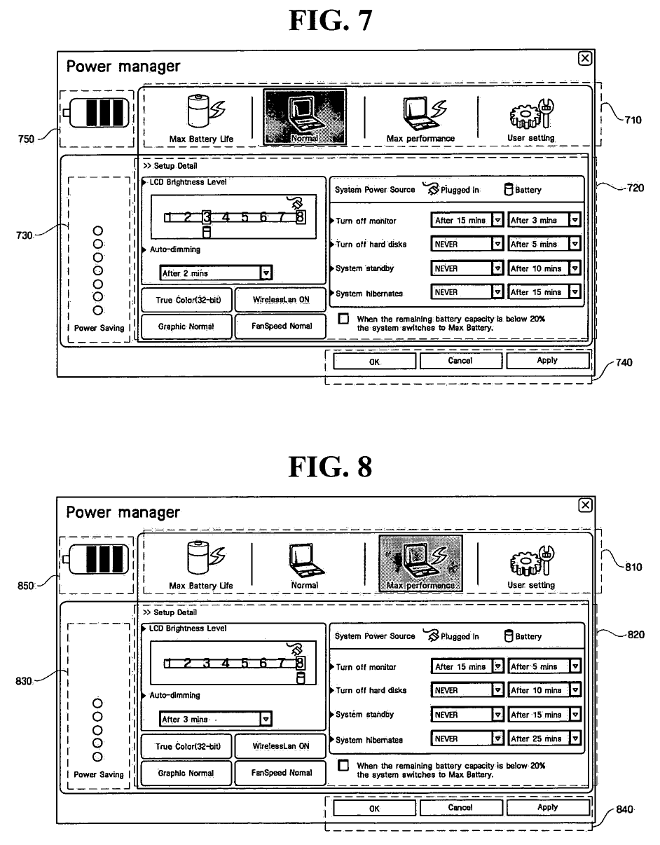

In operation S460, when the user wants to change power-saving level, the user can change power-saving mode in the first region 610. For example, when the user wants to change the current maximum battery mode into the normal mode, an icon representing the normal mode in the first region 610 is selected. Then, a user interface shown in FIG. 7 is provided.

Like the user interface shown in FIG. 6, the user interface of FIG. 7 includes a first region 710 for selecting a power-saving mode, a second region 720 for providing a plurality of power-saving state values corresponding to the selected power-saving mode, a third region 740 including an icon for a control input to perform an operation for calculating a power-saving level value using the power-saving state values set in the second region 720 or an icon for cancelling a set power-saving state value, a fourth region 730 for providing information about the power-saving state value calculated by the control input, and a fifth region 750 for providing information about the state of a current battery. The information provided in the fifth region 750 is information in which the controller 310 directly checks the state of the power unit 340 to provide the state of the power unit 340 to the user via the display unit 330. Currently, in the first region 710, an icon representing normal mode is indicated by a shadow and represents the state of the current power-saving mode is the normal mode. In the second region 720, the power-saving state values are provided. Preferably, in the normal mode, the power-saving state values are previously fixed so that the user cannot change them arbitrarily. In the fourth region 730, the power-saving level in the normal mode is represented. The information about the power-saving level can be obtained by performing an operation for predetermined power-saving state values by the controller 310 in operation S440. This method has been described above. As a method of visually displaying the power-saving level to the user, in FIG. 7, since the current power-saving mode is normal mode, a smaller value of the power-saving level in the fourth region 730 than the value of the power-saving level in the maximum battery mode of FIG. 6 is displayed in operation S450.

In operation S460, when the user wants to change a power-saving level again, the user can change the power-saving mode in the first region 710. For example, when the user wants to change the current normal mode into the maximum performance mode, an icon representing the maximum performance mode in the first region 710 is selected. Then, a user interface shown in FIG. 8 is provided.

Like the user interface shown in FIG. 7, the user interface of FIG. 8 includes a first region 810 for selecting a power-saving mode, a second region 820 for providing a plurality of power-saving state values corresponding to the selected power-saving mode, a third region 840 including an icon for a control input to perform an operation for calculating a power-saving level value using the power-saving state values set in the second region 820 or an icon for cancelling a set power-saving state value, a fourth region 830 for providing information about the power-saving state value calculated by the control input, and a fifth region 850 for providing information about the state of a current battery. The information provided in the fifth region 850 is information in which the controller 310 directly checks the state of the power unit 340 to provide the state of the power unit 340 to the user via the display unit 330. Currently, in the first region 810, an icon representing the maximum performance mode is indicated by shadow and represents the state of the current power-saving mode is in maximum performance mode. In the second region 820, the power-saving state values are provided. Preferably, in the maximum performance mode, the power-saving state values are previously fixed so that the user cannot change them arbitrarily. In the fourth region 830, the power-saving level in the maximum performance mode is represented. The information about the power-saving level can be obtained by performing an operation for predetermined power-saving state values using the controller 310 in operation S440. This method has been described above. As a method of visually displaying a power-saving level to the user, in FIG. 8, since the current power-saving mode is the maximum performance mode, a smaller value of a power-saving level in the fourth region 830 than the value of the power-saving level in the normal mode of FIG. 7 is displayed in operation S450.

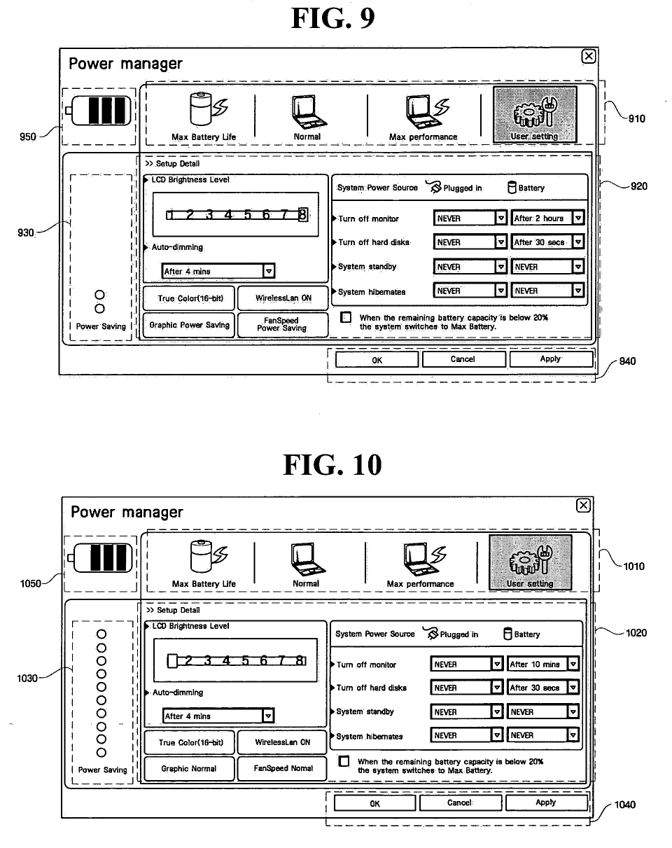

In operation S460, when the user wants to change a power-saving level again, the user can change the power-saving mode in the first region 810. For example, when the user wants to change the current maximum performance mode into the user setting mode, an icon representing the user setting mode in the first region 810 is selected. Then, a user interface shown in FIG. 9 is provided.

Like the user interface shown in FIG. 8, the user interface of FIG. 9 includes a first region 910 for selecting a power-saving mode, a second region 920 for providing a plurality of power-saving state values corresponding to the selected power-saving mode, a third region 940 including an icon for a control input to perform an operation for calculating a power-saving level value or an icon for cancelling a set power-saving state value using the power-saving state values set in the second region 920, a fourth region 930 for providing information about the power-saving state value calculated by the control input, and a fifth region 950 for providing information about the state of the current battery. The information provided in the fifth region 950 is information in which the controller 310 directly checks the state of the power unit 340 to provide the state of the power unit 340 to the user via the display unit 330. Currently, in the first region 910, an icon representing the use setting mode is indicated by shadow and represents that the state of the current power-saving mode is in the use setting mode. In the second region 920, the power-saving state values are provided. Preferably, in the user setting mode, the power-saving state values are not previously fixed but the user can directly set the power-saving state values in operation S430. Accordingly, the user can change the power-saving state values provided in the second region 920, as shown in FIG. 9.

For example, when adjusting of brightness of an LCD is performed at 8 levels and the higher level, the more brighter the LCD, if the user wants to maximize the brightness of the LCD, a mouse is placed in a position where the brightness of the LCD is set and an icon for representing LCD brightness is moved to an eighth level. The operation of newly setting the power-saving state values can be performed by the user input unit 320. Then, an ‘apply’ or ‘OK’ icon of the third region 940 to allow the controller 310 to perform an operation for calculating the power-saving level values using the power-saving state values set in the second region 920 is clicked in operation S440. Then, in operation S450, information about the power-saving levels corresponding to the calculated power-saving state values is visually provided to the user in the fourth region 930.

When the user wants to change the power-saving levels not by changing the user setting mode which is the current power-saving mode but by changing only the power-saving state values, in operation S460, the power-saving state values provided in the second region 920 are changed so that the power-saving mode can be changed. For convenience of explanation, a user interface for changing the power-saving state values is further described in FIG. 10.

For example, if the user wants to minimize the brightness of the LCD, the mouse is placed in the position where the brightness of the LCD is set and the icon for representing LCD brightness is moved to a first level. The operation of changing the setting of the power-saving state values can be performed by the user input unit 320. Then, an ‘apply’ or ‘OK’ icon in a third region 1040 to allow the controller 310 to perform an operation for calculating the power-saving level values using the power-saving state values set in a second region 1020 is clicked in operation S440. Then, in operation S450, information about the power-saving levels corresponding to the calculated power-saving state values is visually provided to the user in the fourth region 1030. Compared to FIG. 9, since the brightness of the LCD is minimized, the power-saving level increases. If a ‘cancel’ icon of the third region 1040 is selected, the power-saving state values newly set by the user are cancelled.

According to the above-described embodiments of the present invention, in a portable electronic device using a battery, a power-saving level is displayed according to a power-saving mode so that, when the user changes the power-saving mode, a power consumption level of the portable electronic device can be easily recognized.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for displaying a power-saving level, the apparatus comprising:
a peripheral unit including a plurality of modules that operate by power supplied by a power unit;
a user input unit to which a predetermined power-saving mode and power-saving state values for modules corresponding to the power-saving mode are input;
a controller calculating power-saving level values using the input power-saving state values and providing information about the calculated power-saving level values; and
a display unit providing the information to the user.

2. The apparatus of claim 1, wherein the power-saving mode comprises a mode in which the power-saving state values have been already set.

3. The apparatus of claim 1, wherein the power-saving mode comprises a mode in which the power-saving state values are directly designated by a user input.

4. The apparatus of claim 1, wherein the power-saving state values comprise information representing a brightness of a screen of the display unit.

5. The apparatus of claim 1, wherein the power-saving state values comprise information representing an on/off state of a wireless LAN module.

6. The apparatus of claim 1, wherein the power-saving state values comprise graphic information.

7. The apparatus of claim 1, wherein the power-saving level values are determined by a sum of the power-saving state values to which weighed values are given.

8. The apparatus of claim 1, wherein the display unit provides the information to the user by representing the information as graphics.

9. The apparatus of claim 1, wherein the display unit provides a user interface to the user, and
wherein the user interface comprises:
a first region including an icon representing a plurality of power-saving modes;
a second region providing a plurality of power-saving state values corresponding to the power-saving modes;
a third region including an icon for a control input to perform an operation for calculating a power-saving level value using the power-saving state values set in the second region; and
a fourth region providing information about the power-saving state value calculated by the control input.

10. The apparatus of claim 9, wherein the user interface further comprises a fifth region providing information about a state of a battery.

11. A user interface of an apparatus for displaying a power-saving level, the user interface comprising:
a first region including an icon representing a plurality of power-saving modes;
a second region providing a plurality of power-saving state values corresponding to the power-saving modes;
a third region including an icon for a control input to perform an operation for calculating a power-saving level value using the power-saving state values set in the second region; and
a fourth region providing information about the power-saving state value calculated by the control input.

12. The apparatus of claim 11, wherein the power-saving mode comprises a mode in which the power-saving state values have been already set.

13. The apparatus of claim 11, wherein the power-saving mode comprises a mode in which the power-saving state values are directly designated by a user input.

14. The apparatus of claim 11, wherein the power-saving state values comprise information representing the brightness of a screen.

15. The apparatus of claim 11, wherein the power-saving state values comprise information representing an on/off state of a wireless LAN module.

16. The apparatus of claim 11, wherein the power-saving state values comprise graphic information.

17. The apparatus of claim 11, wherein the power-saving level values are determined by a sum of the power-saving state values to which weighed values are given.

18. The apparatus of claim 11, wherein the fourth region provides the information to the user by representing the information as graphics.

19. The apparatus of claim 11, wherein the user interface further comprises a fifth region providing information about a state of a battery.

20. A method of displaying a power-saving level, the method comprising:
receiving a predetermined power-saving mode and power-saving state values for modules corresponding to the power-saving mode;
calculating power-saving level values using the input power-saving state values; and
providing information about the calculated power-saving level values.

21. The method of claim 20, wherein the power-saving mode comprises a mode in which the power-saving state values have been already set.

22. The method of claim 20, wherein the power-saving mode comprises a mode in which the power-saving state values are directly designated by a user input.

23. The method of claim 20, wherein the power-saving state values comprise information representing a brightness of a screen.

24. The method of claim 20, wherein the power-saving state values comprise information representing an on/off state of a wireless LAN module.

25. The method of claim 20, wherein the power-saving state values comprise graphic information.

26. The method of claim 20, wherein the power-saving level values are determined by a sum of the power-saving state values to which weighed values are given.

27. The method of claim 20, wherein the providing comprises providing the information to the user by representing the information as graphics.

28. The method of claim 20, wherein the providing comprises providing a user interface comprising:
a first region including an icon representing a plurality of power-saving modes;
a second region providing a plurality of power-saving state values corresponding to the power-saving modes;
a third region including an icon for a control input to perform an operation for calculating a power-saving level value using the power-saving state values set in the second region; and
a fourth region providing information about the power-saving state value calculated by the control input.

29. The method of claim 28, wherein the user interface further comprises a fifth region providing information about a state of a battery.

30. An apparatus for displaying a power-saving level, the apparatus comprising:
peripheral unit including a plurality of modules that operate by supplied power;
user input means for receiving a predetermined power-saving mode input and power-saving state values for modules corresponding to the power-saving mode; and
control means for calculating power-saving level values using the received power-saving state values and providing information about the calculated power-saving level values.

31. The apparatus of claim 30, wherein the modules include a hard disk, a fan, and a wireless LAN module.
